(19) United States
(12) Patent Application Publication
(10) Pub. No.: US 2018/0066553 A1
(43) Pub. Date: Mar. 8, 2018

(54) Drive Device, In Particular For A Vehicle

(71) Applicant: MAN TRUCK & BUS AG, Munchen (DE)

(72) Inventors: Dominik RENNER, Ansbach (DE); Thomas Malischewski, Heilsbronn (DE)

(73) Assignee: MAN TRUCK & BUS AG

(21) Appl. No.: 15/694,376

(22) Filed: Sep. 1, 2017

(30) Foreign Application Priority Data
Sep. 2, 2016 (DE) 102016 010 572.0

(51) Int. Cl. F01N 3/04; F01N 3/20; F02B 37/18; F01N 13/10; F02B 37/00; F01P 3/20; F01K 23/06; B01D 53/94

(52) U.S. Cl. CPC F01N 3/043; F01N 3/2066; F02B 37/183; F01N 13/10; F02B 37/004; F01P 3/20; B01D 2255/20723; B01D 53/9418; B01D 53/9495; F01N 2260/024; F01N 2610/02; F01P 2060/12; F01K 23/065

(57) ABSTRACT

A drive device for a vehicle with and an exhaust gas tract connected to engine. The exhaust gas tract has a main line with an exhaust gas turbine of a turbocharger and a catalytic convertor downstream of the turbine. The exhaust gas tract has a bypass, by which at least some of the is conductible past a turbine wheel of the turbine such that the exhaust gas is conductible out of the main line at at least one a conducting-out region into the bypass line upstream of the turbine wheel. The bypass exhaust gas flow in the bypass line is conductible into the main line at downstream of the turbine wheel (41) and upstream of the catalytic convertor. To prevent overheating of the catalytic convertor, a cooling device is provided, by which the bypass exhaust gas flow flowing through the bypass line is coolable.

### BACKGROUND OF THE INVENTION

1. Field of the Invention

The invention relates to a drive device, in particular for a vehicle, to a method for operating a drive device, and to a vehicle, in particular a commercial vehicle, with the drive device.

2. Description of the Related Art

It is generally known to use an exhaust gas turbocharger to optimize the operation of an internal combustion engine. It is also known in this connection to provide a bypass line at an exhaust gas tract connected to the internal combustion engine, by which bypass line at least some of the exhaust gas flowing through the exhaust gas tract can be conducted past a turbine wheel of an exhaust gas turbocharger turbine. By a bypass line of this type, it can be simply and effectively prevented that the turbine wheel of the exhaust gas turbine exceeds its maximum rotational speed limit.

DE 103 31 653 A1, for example, discloses an exhaust gas tract, in which the exhaust gas is conducted out of an exhaust gas main line of the exhaust gas tract upstream of an exhaust gas turbine of an exhaust gas turbocharger, as seen in the direction of flow of the exhaust gas, and is conducted as a bypass exhaust gas flow into a bypass line. The bypass exhaust gas flow is conducted again into the exhaust gas main line downstream of the turbine wheel and upstream of a catalytic convertor.

Furthermore, it is also known to provide an SCR catalytic convertor at an exhaust gas tract, by which SCR catalytic convertor nitrogen oxides emitted by the internal combustion engine, which is configured in particular as a diesel engine, are reduced with ammonia as the reducing agent. The ammonia is customarily conducted here in the form of an aqueous urea solution into the exhaust gas tract upstream of the SCR catalytic convertor. In the case of certain types of vehicle, in particular in the case of commercial vehicles, SCR catalytic convertors with vanadium as the active component have proven particularly effective for reducing the nitrogen oxides. However, vanadium-containing SCR catalytic convertors have a relatively low overheating temperature of approximately 500° C., after which the purification of the exhaust gas deteriorates and the catalytic convertor begins to degrade. On account of the ever increasing specific powers of the internal combustion engines and the exhaust gas temperatures which likewise increase as a result, in particular the vanadium-containing SCR catalytic convertors are therefore coming in the mean time to their physical limits, which makes the use said catalytic convertors more difficult.

### SUMMARY OF THE INVENTION

It is therefore the object of the invention to provide a drive device, in particular for a vehicle, and a method for operating a drive device, by which drive device and method overheating of a catalytic convertor of an exhaust gas tract can be countered in a simple and effective manner.

According to one aspect of the invention, a drive device, in particular for a vehicle, is proposed, with an internal combustion engine and an exhaust gas tract which is connected to the internal combustion engine, wherein the exhaust gas tract has an exhaust gas main line with at least one exhaust gas turbine of an exhaust gas turbocharger and at least one catalytic convertor arranged downstream of the exhaust gas turbine, as seen in the direction of flow of the exhaust gas, wherein the exhaust gas tract has at least one bypass line, by which at least some of the exhaust gas flowing through the exhaust gas tract is conductible past a turbine wheel of the exhaust gas turbine in such a manner that the exhaust gas is conductible out of the exhaust gas main line at at least one exhaust gas conducting-out region arranged upstream of the turbine wheel and is conductible into the bypass line. In addition, the bypass exhaust gas flow flowing through the bypass line can be conducted again into the exhaust gas main line at an exhaust gas conducting-in region arranged downstream of the turbine wheel and upstream of the catalytic convertor. According to one aspect of the invention, in particular for preventing overheating of the at least one catalytic convertor, a cooling device is provided, by which the bypass exhaust gas flow flowing through the bypass line can be cooled.

As a result, overheating of the catalytic convertor arranged downstream of the exhaust gas turbine can be simply and effectively countered since the exhaust gas flow conducted past the turbine wheel of the exhaust gas turbine can now be cooled by the cooling device according to the invention. The cooled bypass exhaust gas flow is then conducted again into the exhaust gas main line upstream of the at least one catalytic convertor, as a result of which the exhaust gas temperature in the region of the catalytic convertor is reduced and the catalytic convertor is no longer so greatly heated up. The bypass therefore takes on two functions here. Firstly, the charging pressure can be adjusted via the bypass mass flow since, depending on the bypass mass flow, the mass flow via the turbine wheel increases or drops and therefore the charging pressure of the internal combustion engine also increases or drops. In addition, thermal energy can be extracted from the bypass mass flow, as a result of which a lower exhaust gas temperature arises downstream of the exhaust gas conducting-in region than in the case of a system without the cooling device according to one aspect of the invention.

In a preferred refinement of the drive device according to one aspect of the invention, the cooling device here is designed in such a manner that, by said cooling device, the maximum exhaust gas temperature in the region of the catalytic convertor, which is configured in the form of an SCR catalytic convertor, can be reduced by at least 20° C., preferably by at least 40° C. As a result, overheating of the SCR catalytic convertor can already be effectively countered.

In a preferred specific refinement, the cooling device has at least one bypass heat exchanger, which is assigned to the bypass line, by which heat can be removed from the bypass exhaust gas flow flowing through the bypass line. By a bypass heat exchanger of this type, the bypass exhaust gas flow flowing through the bypass line can be effectively cooled. In addition, by a heat exchanger of this type, the cooling of the bypass exhaust gas flow or the quantity of heat removed from the bypass exhaust gas flow can also be set as desired in a simple manner. A liquid coolant can expediently flow through the bypass heat exchanger here. The bypass heat exchanger can operate, for example, according to the counterflow principle, according to the parallel flow principle or according to the cross flow principle. In a particularly preferred refinement, the bypass heat exchanger is also formed by a component which is separate from the exhaust gas turbine, in order to simplify the construction of the drive device according to one aspect of the invention.

In a specific refinement, the bypass heat exchanger can be, for example, part of a coolant circuit. It is preferably provided here that the bypass heat exchanger is incorporated into a coolant circuit, by which not only can the bypass exhaust gas flow, but also the internal combustion engine be cooled.

As an alternative to the coolant circuit, the bypass heat exchanger can also be part of an energy recovery system, by which the thermal energy of the exhaust gas can be converted into a useable form of energy. In a preferred specific configuration, the conversion of energy takes place here by a thermodynamic cycle, in particular by a Clausius-Rankine cycle.

Furthermore, a control device is advantageously provided, by which the quantity of exhaust gas conducted into the bypass line can be controlled depending on at least one control parameter. In a preferred specific refinement, the control device for controlling the quantity of exhaust gas introduced into the bypass line has at least one valve. Said at least one valve is preferably assigned here to the bypass line in order to simplify the construction of the drive device according to the invention. Alternatively or additionally the valve could, however, also be designed as a waste gate valve on the exhaust gas turbine side. A waste gate valve of this type has a valve seat formed by a turbine housing of the exhaust gas turbine and a valve body which is shiftable relative to the turbine housing.

The control device preferably has a control unit, by which the, preferably electrically actuable, valve can be controlled in order to set at least one defined valve position. With a control of this type, the quantity of exhaust gas conducted into the bypass line can be set as desired simply and reliably. It is preferably provided here that the at least one control parameter is formed by the charging pressure of the combustion air flowing through an intake tract of the internal combustion engine and/or by the exhaust gas temperature in the region of the at least one catalytic convertor. The charging pressure of the combustion air flowing through the intake tract can be measured here, for example, by a pressure sensor connected in terms of signalling to the control unit. Similarly, for example, the exhaust gas temperature in the region of the catalytic convertor can also be measured by a temperature sensor which is arranged in the region of the catalytic convertor and is connected in terms of signalling to the control unit.

As an alternative to control using the control unit, the at least one valve can also be formed by a valve which is actuable by air pressure, wherein the valve is connected in terms of flow to an intake tract of the internal combustion engine in such a manner that the valve automatically opens and closes depending on the charging pressure of the combustion air flowing through the intake tract as the control parameter. With a valve of this type, the quantity of exhaust gas conducted into the bypass line can be reliably and effectively controlled depending on the charging pressure of the combustion air.

In principle, it would, of course, be conceivable to provide the exhaust gas conducting-out region directly at the exhaust gas turbine. However, it is preferred if the exhaust gas conducting-out region is arranged upstream of the exhaust gas turbine, as seen in the direction of flow of the exhaust gas, in order to keep the construction of the drive device according to the invention simple. Likewise preferably, the exhaust gas conducting-in region can also be arranged downstream of the exhaust gas turbine, as seen in the direction of flow of the exhaust gas.

The main exhaust feed can expediently have an exhaust gas combining portion formed by at least one exhaust gas manifold and by which a plurality of partial exhaust gas flows coming from the internal combustion engine can be combined to form a single overall exhaust gas flow. It is preferably provided here for a combining region of the exhaust gas tract, at which combining region the partial exhaust gas flows are combined to form the overall exhaust gas flow, is arranged upstream of the exhaust gas turbine and/or upstream of the turbine wheel of the exhaust gas turbine, in order to conduct the overall exhaust gas flow via the exhaust gas turbine or via the turbine wheel of the exhaust gas turbine.

In a preferred refinement, the at least one exhaust gas conducting-out region of the exhaust gas tract is arranged downstream of the exhaust gas flow combining region. At least some of the combined overall exhaust gas flow can thereby be conducted into the bypass line. It is preferably provided here that the at least one exhaust gas conducting-out region of the exhaust gas tract is arranged in a defined near region in the region of the exhaust gas turbine. As an alternative to the arrangement of the exhaust gas conducting-out region downstream of the exhaust gas flow combining region, the exhaust gas conducting-out region can also be arranged upstream of the exhaust gas flow combining region. As a result, at least a partial exhaust gas flow can be conducted into the bypass line.

It is preferably provided here that at least one exhaust gas conducting-out region is in each case provided at a plurality of, in particular at two, line portions of the main exhaust gas line, through which line portions a partial exhaust gas flow in each case flows, in order to be able to conduct a plurality of partial exhaust gas flows into the bypass line and therefore to realise a multi-flow exhaust gas feed.

In a specific refinement, the drive device can also have a plurality of, in particular two, exhaust gas turbochargers. It is preferably provided here that the exhaust gas conducting-out region is arranged upstream of the turbine wheels of the plurality of exhaust gas turbochargers. The exhaust gas conducting-in region can then be arranged downstream of the turbine wheels of all of the exhaust gas turbochargers or between two turbine wheels of the plurality of exhaust gas turbochargers, as seen in the direction of flow of the exhaust gas. Overheating of a catalytic convertor arranged downstream of the exhaust gas turbines can thereby be simply and effectively countered in the case of multi-stage supercharging of the internal combustion engine.

The at least one catalytic convertor is preferably formed by an SCR catalytic convertor, by which nitrogen oxides of the exhaust gas emitted by the internal combustion engine can be reduced with ammonia as the reducing agent. In addition, the SCR catalytic convertor preferably has vanadium as the active component.

To solve the problem already mentioned, a method for operating a drive device is disclosed, wherein the drive device has an internal combustion engine and an exhaust gas tract connected to the internal combustion engine. The exhaust gas tract has an exhaust gas main line with at least one exhaust gas turbine of an exhaust gas turbocharger and at least one catalytic convertor arranged downstream of the exhaust gas turbine, as seen in the direction of flow of the exhaust gas. The exhaust gas tract has at least one bypass line, by which at least some of the exhaust gas flowing through the exhaust gas tract is conducted past a turbine wheel of the exhaust gas turbine in such a manner that the exhaust gas is conducted out of the exhaust gas main line at at least one exhaust gas conducting-out region arranged upstream of the turbine wheel and conducted into the bypass line. The bypass exhaust gas flow flowing through the bypass line is then conducted again into the exhaust gas main line downstream of the turbine wheel and upstream of the catalytic convertor. According to one aspect of the invention, in particular for preventing overheating of the at least one catalytic convertor, a cooling device is provided, by means of which the bypass exhaust gas flow flowing through the bypass line is cooled. In addition, it is preferably provided here that a control device is provided, by means of which the quantity of exhaust gas introduced into the bypass line and/or the cooling power of the cooling device is controlled depending on at least one control parameter.

The advantages arising through the method procedure according to one aspect of the invention are identical to the already acknowledged advantages of the drive device according to the invention, and therefore are not repeated at this juncture.

Furthermore, a vehicle, in particular a utility vehicle, with the drive device according to the invention is also claimed. The advantages arising therefrom are likewise identical to the already acknowledged advantages of the drive device according to the invention and are likewise not repeated here.

Apart from, for example, in the cases of unambiguous dependences or uncombinable alternatives, the advantageous embodiments and/or developments of the invention that are explained above and/or are reproduced in the dependent claims can be used individually or else in any combination with one another.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and its advantageous embodiments and/or developments and also the advantages thereof are explained in more detail merely by way of example below with reference to drawings.

In the drawings:

FIG. 1 is a schematic illustration, from which the construction of a drive device is clear;

FIG. 2 is an illustration according to FIG. 1, in which, in comparison to FIG. 1, a bypass exhaust gas flow through a bypass line of the drive device is opened out;

FIG. 3 is, in an illustration according to FIG. 2, of a drive device;

FIG. 4 is, in an illustration according to FIG. 2, a drive device;

FIG. 5 is, in an illustration according to FIG. 2, a drive device;

FIG. 6 is, in an illustration according to FIG. 2, a drive device;

FIG. 7 is, in an illustration according to FIG. 2, a drive device; and

FIG. 8 is, in a schematic illustration, part of a drive device.

### DETAILED DESCRIPTION OF THE PRESENTLY PREFERRED EMBODIMENTS

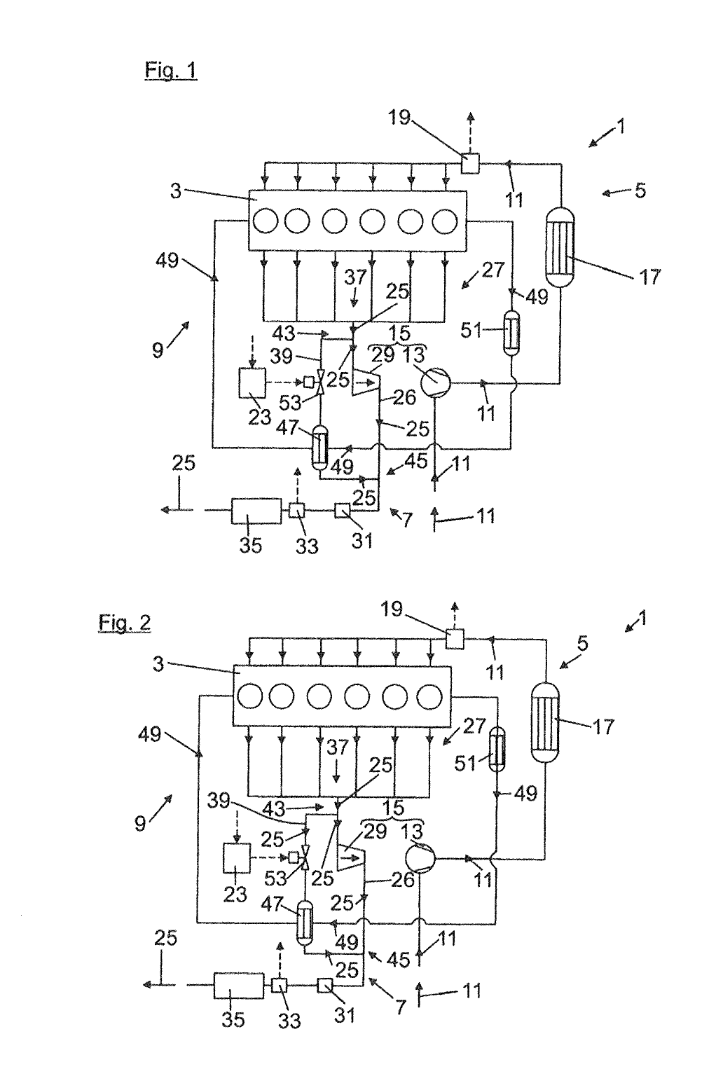

FIG. 1 shows a schematic illustration of a first embodiment of a drive device 1 according to one aspect of the invention. The drive device 1 has an internal combustion engine 3 with, by way of example here, six cylinders, an intake tract 5, an exhaust gas tract 7 and a coolant circuit 9.

Combustion air 11 from the free surroundings is supplied here to the internal combustion engine 3 by the intake tract 5. The intake tract 5 has here, as seen in the flow direction of the air, a compressor 13 of an exhaust gas turbocharger 15, an air cooler 17 and a pressure sensor 19. The combustion air 11 drawing into the intake tract 5 is first of all compressed by the compressor 13. Subsequently, the compressed combustion air 11 is cooled by the air cooler 17 and is finally supplied to the internal combustion engine 3. The charging pressure of the combustion air 11 directly upstream of the internal combustion engine 3 is measured by the pressure sensor 19. The charging pressure measured by the pressure sensor 19 is then transmitted to a control unit 23 of the drive device 1, said control unit being connected to the pressure sensor 21 in terms of signalling.

Furthermore, an exhaust gas 25 emitted by the external combustion engine 3 is conducted into the free surroundings by the exhaust gas tract 7, which is connected to the internal combustion engine 3. The exhaust gas tract 7 here has a main exhaust gas line 26 which, as seen in the direction of flow of the exhaust gas, has an exhaust gas combining portion 27, an exhaust gas turbine 29 of the exhaust gas turbocharger 15, an injector 31, a temperature sensor 33 and an SCR catalytic convertor 35.

The partial exhaust gas flows, six here by way of example, coming from the cylinders of the internal combustion engine 3 are combined by the exhaust gas combining portion 27 to form a single overall exhaust gas flow. The exhaust gas combining portion 27 is formed here by way of example by a single exhaust gas manifold element which here by way of example has six inflow openings and a single outflow opening. In addition, a combining region 37 at which the partial exhaust gas flows are combined to form the overall exhaust gas flow is arranged here upstream of the exhaust gas turbine 29.

Furthermore, the exhaust gas turbine 29 of the exhaust gas turbocharger 15 is driven with the exhaust gas 25 flowing through the main exhaust gas line 26. Here by way of example, an aqueous urea solution can be injected into the main exhaust gas line 26 by the injector 31. The exhaust gas temperature immediately upstream of the SCR catalytic convertor 35 is measured by the temperature sensor 33 arranged here directly upstream of the SCR catalytic convertor 35. The exhaust gas temperature measured by the temperature sensor 33 is then transmitted to the control unit 23, which is connected in terms of signalling to the temperature sensor 33. By the SCR catalytic convertor 35, nitrogen oxides of the exhaust gas 25 emitted by the internal combustion engine 3 are reduced with ammonia as the reducing agent. The ammonia is provided here by the aqueous urea solution conducted into the main exhaust gas line 24 by the injector 31. In addition, the SCR catalytic convertor 35 has here by way of example vanadium as the active component.

As is furthermore clear from FIG. 1, the exhaust gas tract 7 also has a bypass line 39. By the bypass line 39, at least some of the exhaust gas 25 flowing through the exhaust gas tract 7 can be conducted past a turbine wheel 41 (FIG. 8) of the exhaust gas turbine 29. The exhaust gas 25 is conducted here out of the exhaust gas main line 26 at an exhaust gas conducting-out region 43 arranged downstream of the combining region 37 and upstream of the exhaust gas turbine 29 and conducted into the bypass line 39. At an exhaust gas conducting-in region 45 arranged downstream of the exhaust gas turbine 29 and upstream of the injector 31, the bypass exhaust gas flow flowing through the bypass line 39 is then conducted again into the exhaust gas main line 26.

According to FIG. 1, the bypass line 39 is also assigned here a heat exchanger 47, by which heat can be removed from the bypass exhaust gas flow flowing through the bypass line 39 or can be cooled by the bypass exhaust gas flow flowing through the bypass line 39. The bypass heat exchanger here is part of the coolant circuit 9 and a liquid coolant 49 of the coolant circuit 9 flows through it. By the coolant circuit 9, not only is the bypass exhaust gas flow, but also the internal combustion engine 3, cooled here. The coolant circuit 9 has the bypass heat exchanger 47, the internal combustion engine 3 and a coolant cooler 51, as seen in the direction of flow of the coolant.

As is furthermore shown in FIG. 1, the bypass line 39 is assigned a valve 53, which is by way of example a straight-way valve, by which the quantity of exhaust gas conducted into the bypass line 39 can be controlled. The valve 53 is arranged here upstream of the bypass heat exchanger 47, as seen in the direction of flow of the exhaust gas. In addition, the valve 53 which here by way of example is electrically actuable is connected in terms of signalling to the control unit 23, and therefore the valve 53 can be activated by the control unit 23. As a result, the valve opening or the valve position of the valve 53 can be controlled or set by the control unit 23 depending on the charging pressure detected by the pressure sensor 29 and the temperature detected by the temperature sensor 33. In FIG. 1, the valve 53 is in its closed position. In this closed position, the valve 53 blocks the bypass line 39, and therefore exhaust gas 25 cannot flow past the valve 53. In FIG. 2, the valve 53 is in its open position. In said open position, the exhaust gas can then flow past the valve 53 and can therefore flow via the exhaust gas turbine 29 and also via the bypass heat exchanger 47. The exhaust gas 25 flowing via bypass line 39 is then cooled by the bypass heat exchanger 47, as a result of which overheating of the SCR catalytic convertor 35 is effectively countered.

FIG. 3 shows a second embodiment of the drive device 1 according to one aspect of the invention. In comparison to the first embodiment, which is shown in FIG. 2, the exhaust gas combining region 37 is not arranged upstream of the exhaust gas turbine 29, but rather directly at the exhaust gas turbine 29. In addition, the exhaust gas combining portion 27 is formed here by way of example by two separate exhaust gas manifold elements 57, of which each has here by way of example three inlet openings and a single outlet opening. Each exhaust gas manifold element 57 is connected here by flange connections to the internal combustion engine 3 and to the exhaust gas turbine 29. In addition, each exhaust gas manifold element 57 here also has a combining region 59 at which the partial exhaust gas flows flowing through the respective exhaust gas manifold element 57 are combined to form a single exhaust gas flow. In addition, the exhaust gas conducting-out region 43 is provided here at one of the two exhaust gas manifold elements 57 downstream of the connecting region 59 and upstream of the exhaust gas turbine 29.

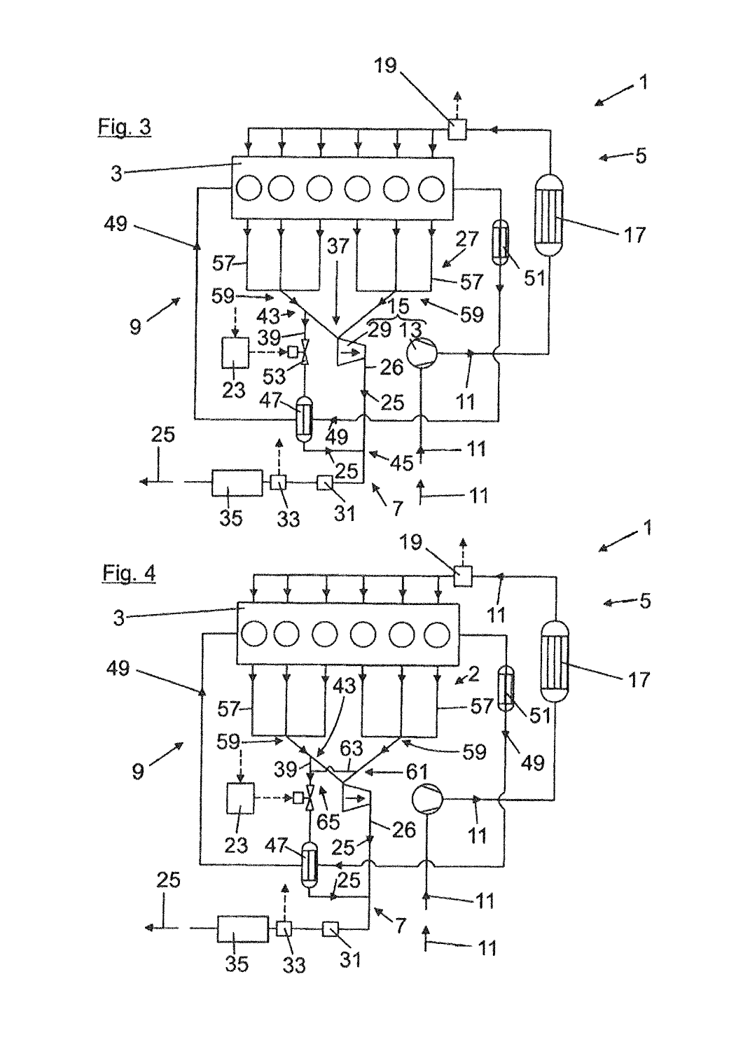

FIG. 4 shows a third embodiment of the drive device 1. In comparison to the embodiment shown in FIG. 3, a further exhaust gas conducting-out region 61 is provided at the other of the two exhaust gas manifold elements 57 downstream of the combining region 59 and upstream of the exhaust gas turbine 29. At said exhaust gas conducting-out region 61, the exhaust gas 25 flowing through the exhaust manifold element 57 can then flow into a bypass line 63 which leads at a combining region 65 into the bypass line 39. The combining region 65 is arranged here upstream of the valve 53.

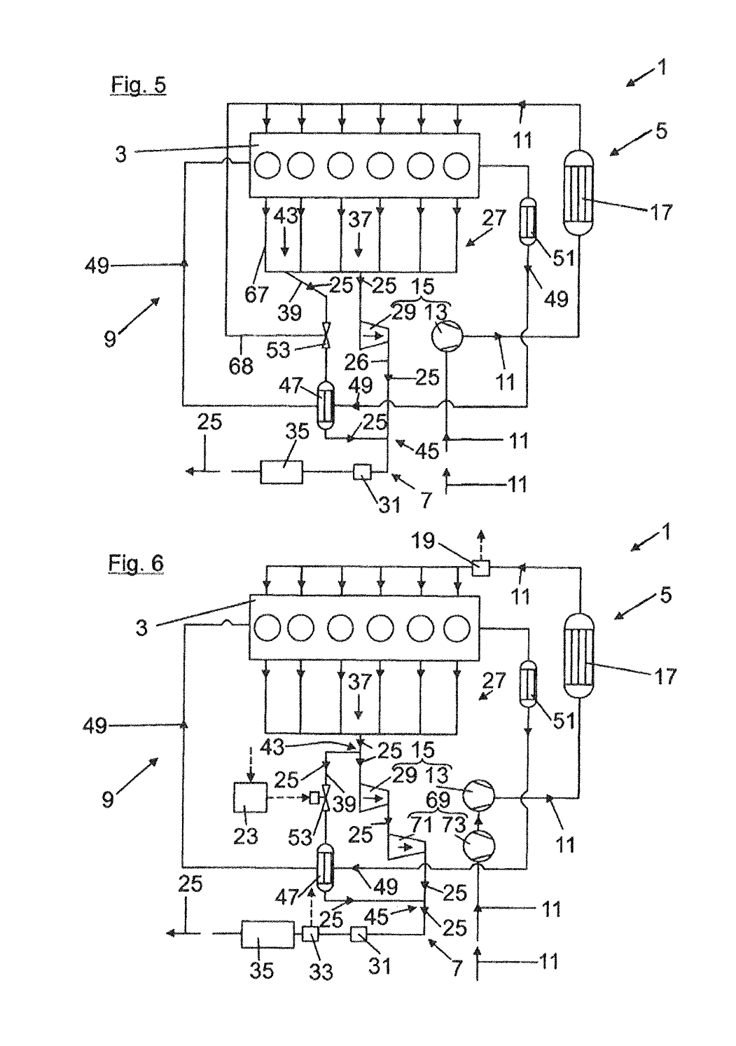

FIG. 5 shows a fourth embodiment of the drive device 1 according to the invention. In comparison to the first embodiment, which is shown in FIG. 2, the exhaust gas conducting-out region 43 is not arranged here downstream of the exhaust gas combining region 37, but rather upstream of the exhaust gas combining region 37. Specifically, the exhaust gas conducting-out region 43 is assigned here to an outer exhaust gas line 67 of the exhaust gas manifold element, through which exhaust gas line an outer partial exhaust gas flow of the internal combustion engine 3 flows. In addition, the valve 53 is formed here by a valve, which is actuable by air pressure. The valve 53 is connected here in terms of flow to the intake tract 3 of the internal combustion engine via a pressure line 68, and therefore the valve 53 automatically opens and closes depending on the charging pressure of the combustion air 11 flowing through the intake tract 3.

FIG. 6 shows a fifth embodiment of the drive device. In comparison to the first embodiment, shown in FIG. 2, the drive device 1 here has a further exhaust gas turbocharger 69. The exhaust gas turbocharger 69 forms a low pressure exhaust gas turbocharger here and has a low pressure exhaust gas turbine 71 arranged downstream of the exhaust gas turbine 29 and upstream of the exhaust gas conducting-in region 45, as seen in the direction of flow of the exhaust gas, and a low pressure compressor 73 arranged upstream of the compressor 13, as seen in the direction of flow of the combustion air. In addition, the exhaust gas turbocharger 15 forms a high pressure exhaust gas turbocharger here.

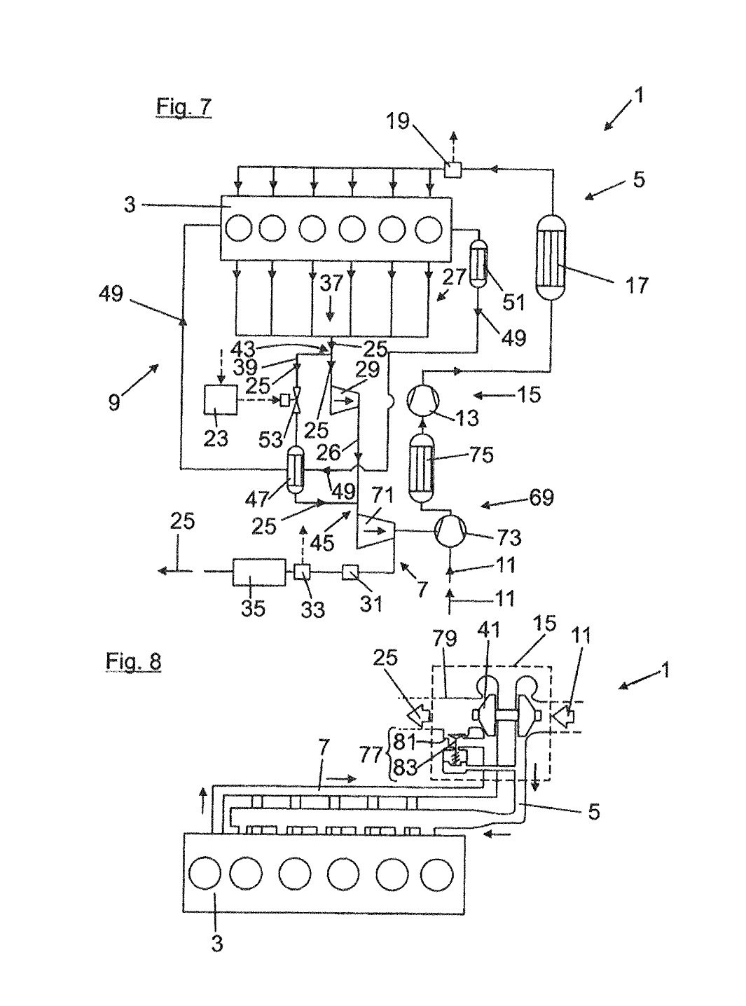

FIG. 7 shows a sixth embodiment of the drive device. In comparison to the embodiment which is shown in FIG. 6, the exhaust gas conducting-in region 45 is arranged here between the two exhaust gas turbines 29, 71 of the exhaust gas tract 7, as seen in the direction of flow of the exhaust gas. In addition, a further air cooler 75 is arranged here between the two compressors 13, 73, as seen in the direction of flow of the air.

FIG. 8 shows a seventh embodiment of the drive device 7. In comparison to the embodiments shown in FIGS. 1 to 7, the exhaust gas turbine 29 here additionally has a waste gate valve 77. A turbine housing 79 of the exhaust gas turbine 29 forms a valve seat 81 of the waste gate valve 77 here. In addition, the waste gate valve 77 has a valve body or sealing body 83 which is shiftable relative to the turbine housing 79.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive device for a vehicle, comprising:
an internal combustion engine;
an exhaust gas tract connected to the internal combustion engine, comprising:
an exhaust gas main line with at least one exhaust gas turbine of an exhaust gas turbocharger;
at least one catalytic convertor arranged downstream of the exhaust gas turbine, in a direction of flow of exhaust gas; and
at least one bypass line, by which at least some of the exhaust gas flowing through the exhaust gas tract is conducted passed a turbine wheel of the exhaust gas turbine such that the exhaust gas is conducted out of the exhaust gas main line at at least one exhaust gas conducting-out region arranged upstream of the turbine wheel and is conducted into the at least one bypass line, and that a bypass exhaust gas flow flowing through the at least one bypass line is conducted again into the exhaust gas main line at an exhaust gas conducting-in region arranged downstream of the turbine wheel and upstream of the at least one catalytic convertor; and
a cooling device by which the bypass exhaust gas flow flowing through the at least one bypass line is cooled to prevent overheating of the at least one catalytic convertor.

2. The drive device according to claim 1,
wherein the cooling device has at least one bypass heat exchanger assigned to the at least one bypass line by which heat is removed from the bypass exhaust gas flow flowing through the at least one bypass line,
wherein at least one of:
a liquid coolant flows through the at least one bypass heat exchanger, and
the at least one bypass heat exchanger is formed by a component separate from the exhaust gas turbine.

3. The drive device according to claim 2, wherein the at least one bypass heat exchanger is part of a coolant circuit.

4. The drive device according to claim 2, wherein the at least one bypass heat exchanger is part of an energy recovery system, by which thermal energy of the exhaust gas is converted into a useable form of energy, wherein conversion of energy takes place by a thermodynamic cycle.

5. Drive device according to claim 1, further comprising:
a control device by which an exhaust gas quantity conducted into the at least one bypass line is controllable depending on at least one control parameter,
wherein the control device has at least one valve assigned to the at least one bypass line.

6. The drive device according to claim 5,
wherein the control device has a control unit, by which the at least one valve is activatable to set at least one defined valve position,
wherein at least one control parameter is formed by at least one of:
a charging pressure of combustion air flowing through an intake tract of the internal combustion engine and
an exhaust gas temperature in a region of the at least one catalytic convertor.

7. The drive device according to claim 5,
wherein the at least one valve is formed by an air pressure actuable valve,
wherein the at least one valve is connected in terms of flow to an intake tract of the internal combustion engine such that the at least one valve automatically opens and closes based at least in part on a charging pressure of combustion air flowing through the intake tract.

8. The drive device according to claim 1, wherein at least one of:
the exhaust gas conducting-out region is arranged upstream of the exhaust gas turbine, and
the exhaust gas conducting-in region is arranged downstream of the exhaust gas turbine.

9. The drive device according to claim 1,
wherein the exhaust gas main line has an exhaust gas combining portion formed by at least one exhaust gas manifold by which a plurality of partial exhaust gas flows coming from the internal combustion engine are combined to form a single overall exhaust gas flow,
wherein a combining region of the exhaust gas tract at which the plurality of partial exhaust gas flows are combined to form an overall exhaust gas flow is arranged at least one of:
upstream of the exhaust gas turbine and
upstream of the turbine wheel of the exhaust gas turbine.

10. The drive device according to claim 9, wherein at least one of:
the at least one exhaust gas conducting-out region of the exhaust gas tract is arranged downstream of the exhaust gas flow combining region, in a defined near region in the region of the exhaust gas turbine, and
the at least one exhaust gas conducting-out region of the exhaust gas tract is arranged upstream of the exhaust gas flow combining region.

11. The drive device according to claim 9, wherein at least one exhaust gas conducting-out region is provided at respective ones of a plurality of line portions of the exhaust gas main line, through which line portions a partial exhaust gas flow flows.

12. The drive device according to claim 1,
wherein at least two exhaust gas turbochargers are provided,
wherein the at least one exhaust gas conducting-out region is arranged upstream of the turbine wheels of the plurality of exhaust gas turbochargers, and in that the exhaust gas conducting-in region is arranged one of downstream of the turbine wheels of the plurality of exhaust gas turbochargers and between two turbine wheels of the plurality of exhaust gas turbochargers, as seen in the direction of flow of the exhaust gas.

13. The drive device according to claim 1, wherein the at least one catalytic convertor is formed by an SCR catalytic convertor, by which nitrogen oxides of the exhaust gas emitted by the internal combustion engine are reducible with ammonia as a reducing agent, wherein the SCR catalytic convertor has vanadium as an active component.

14. A method for operating a drive device, wherein the drive device has an internal combustion engine and an exhaust gas tract which is connected to the internal combustion engine, wherein the exhaust gas tract has an exhaust gas main line with at least one exhaust gas turbine of an exhaust gas turbocharger and at least one catalytic convertor arranged downstream of the exhaust gas turbine, as seen in the direction of flow of the exhaust gas,
conducting via at least one bypass line of the exhaust gas tract at least some of the exhaust gas flowing through the exhaust gas tract is conducted past a turbine wheel of the exhaust gas turbine in such a manner that the exhaust gas is conducted out of the exhaust gas main line at at least one exhaust gas conducting-out region arranged upstream of the turbine wheel and conducted into the at least one bypass line;
conducting bypass exhaust gas flow flowing through the at least one bypass line into the exhaust gas main line at an exhaust gas conducting-in region arranged downstream of the turbine wheel and upstream of the at least one catalytic convertor; and
cooling, by a cooling device, the bypass exhaust gas flow flowing through the at least one bypass line to prevent overheating of the at least one catalytic convertor,
wherein a control device is provided, by which an exhaust gas quantity conducted into at least one of the at least one bypass line and a cooling power of the cooling device is controlled depending on at least one control parameter.

15. A vehicle, with a drive device comprising:
an internal combustion engine;
an exhaust gas tract connected to the internal combustion engine, comprising:
an exhaust gas main line with at least one exhaust gas turbine of an exhaust gas turbocharger;
at least one catalytic convertor arranged downstream of the exhaust gas turbine, in a direction of flow of exhaust gas; and
at least one bypass line, by which at least some of the exhaust gas flowing through the exhaust gas tract is conducted passed a turbine wheel of the exhaust gas turbine such that the exhaust gas is conducted out of the exhaust gas main line at at least one exhaust gas conducting-out region arranged upstream of the turbine wheel and is conducted into the at least one bypass line, and that a bypass exhaust gas flow flowing through the at least one bypass line is conducted again into the exhaust gas main line at an exhaust gas conducting-in region arranged downstream of the turbine wheel and upstream of the at least one catalytic convertor; and
a cooling device by which the bypass exhaust gas flow flowing through the at least one bypass line is cooled to prevent overheating of the at least one catalytic convertor.

16. The drive device according to claim 3, the at least one bypass heat exchanger is incorporated into a coolant circuit for cooling the internal combustion engine.

17. The drive device according to claim 4, wherein the thermodynamic cycle is a Clausius-Rankine cycle.

18. The drive device according to claim 10, wherein at least one exhaust gas conducting-out region is provided at respective ones of a plurality of line portions of the exhaust gas main line, through which line portions a partial exhaust gas flow flows.
